(19) United States
(12) Patent Application Publication
(10) Pub. No.: US 2012/0255662 A1
(43) Pub. Date: Oct. 11, 2012

(54) INTEGRATED NANOFIBER FILTER MEDIA

(75) Inventor: Thomas B. Green, Liberty Township, OH (US)

(73) Assignee: CLARCOR INC., Franklin, TN (US)

(21) Appl. No.: 13/528,276

(22) Filed: Jun. 20, 2012

Related U.S. Application Data
(62) Division of application No. 12/428,232, filed on Apr. 22, 2009.
(60) Provisional application No. 61/047,459, filed on Apr. 24, 2008.

(51) Int. Cl. B01D 67/00; B32B 37/10; B32B 37/06; B32B 37/02

(52) U.S. Cl. 156/62.2; 427/458

(57) ABSTRACT

A filter media is formed from electrospun fine fibers and coarse fibers which are entangled and integrated together into a single fiber composite filter media layer.

### CROSS-REFERENCE TO RELATED PATENT APPLICATIONS

This patent application is a Divisional of co-pending U.S. patent application Ser. No. 12/428,232, filed Apr. 22, 2009, now pending, which claims the benefit of U.S. Provisional Patent Application No. 61/047,459, filed Apr. 24, 2008, the entire teachings and disclosure of which are incorporated herein by reference thereto.

### FIELD OF THE INVENTION

This invention generally relates to filter media, and in particular to a filter media formed from an integrated fiber composite material consisting of entangled coarse fibers and electrospun fine fibers, and method of making the same.

### BACKGROUND OF THE INVENTION

Fluid streams such as liquid flows and gaseous flows (e.g. air flows) often carry particulates that are often undesirable contaminants entrained in the fluid stream. Filters are commonly employed to remove some or all of the particulates from the fluid stream.

Filter media including fine fibers formed using an electrostatic spinning process is also known. Such prior art includes Filter Material Construction and Method, U.S. Pat. No. 5,672,399; Cellulosic/Polyamide Composite, U.S. Patent Publication No. 2007/0163217; and Filtration Medias, Fine Fibers Under 100 Nanometers, And Methods, U.S. Patent Application Ser. No. 12/271,322, the entire disclosure of which are incorporated herein by reference thereto. As shown in these references nanofibers are commonly laid upon a finished preformed filtration media substrate.

### BRIEF SUMMARY OF THE INVENTION

According to embodiments of the present invention, fine fibers as may be formed by electrospinning can be integrated with other more conventional filter media fibers in a common filtration layer. For example, prior to completing a filtration substrate of more conventional and typically larger filtration media fibers, electrospun fine fibers can be integrated with the more conventional and typically larger filtration media fibers.

In one aspect, the invention provides for a filter media comprising an entanglement of coarse fibers having an average fiber diameter of greater than about 1 micron and fine fibers having an average fine fiber diameter of less than about 0.8 micron, wherein the entanglement of coarse fibers and fine fibers form a single integrated filter media composite layer.

In another aspect, the invention provides a method of making a filter media. First, a web of coarse fibers having an average fiber diameter of greater than about 1 micron is formed. Then fine fibers having an average fiber diameter of less than about 0.8 micron are electrospun and entangled with the coarse fibers. Finally, the entanglement of the coarse fibers and fine fibers are integrated to form a single integrated filter media composite layer.

Yet in another aspect, the invention provides a method of forming a filter media including forming a web of coarse fibers prior to completing a filter media substrate, and electrospinning fine fibers and depositing the fine fibers on the web. The web of coarse fibers comprise coarse fibers having an average fiber diameter of greater than about 1 micron, and the electrospun fine fiber having an average fiber diameter of less than about 0.8 micron.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a schematic illustration of an integrated composite filter media according to an embodiment of the present invention;

FIG. 2 is a schematic illustration of a system performing a process of making an integrated fiber composite filter media according to an embodiment of the present invention;

FIG. 3 is a schematic illustration of an integrated fiber composite filter media with a fiber density gradient according to an embodiment of the present invention; and

FIG. 4 is a schematic illustration of an alternative embodiment of the system of FIG. 2.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

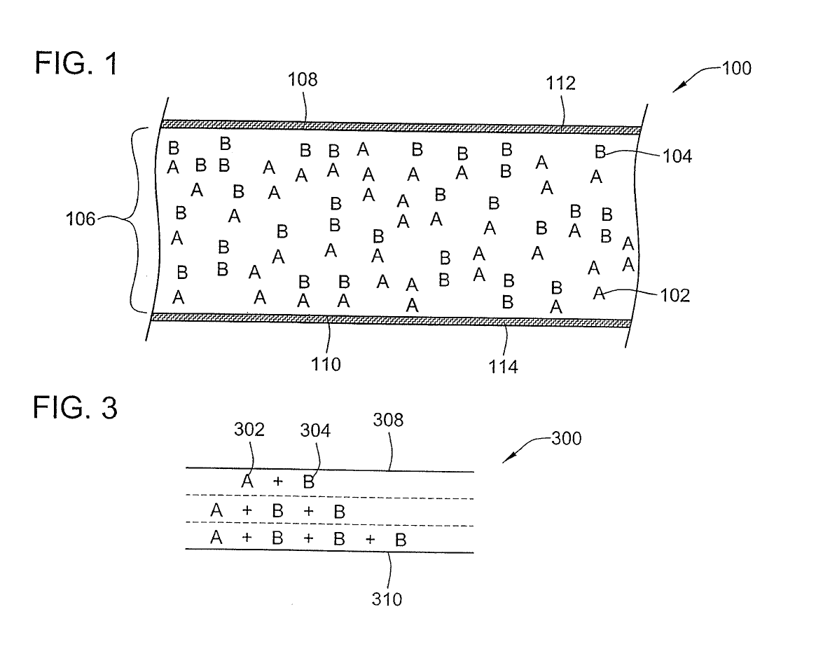

In embodiments of the present invention shown in schematic cross section in FIG. 1 or 3, electrospun fine fibers and non-electrospun coarser fibers are entangled and thereby integrated together in a common filtration media layer.

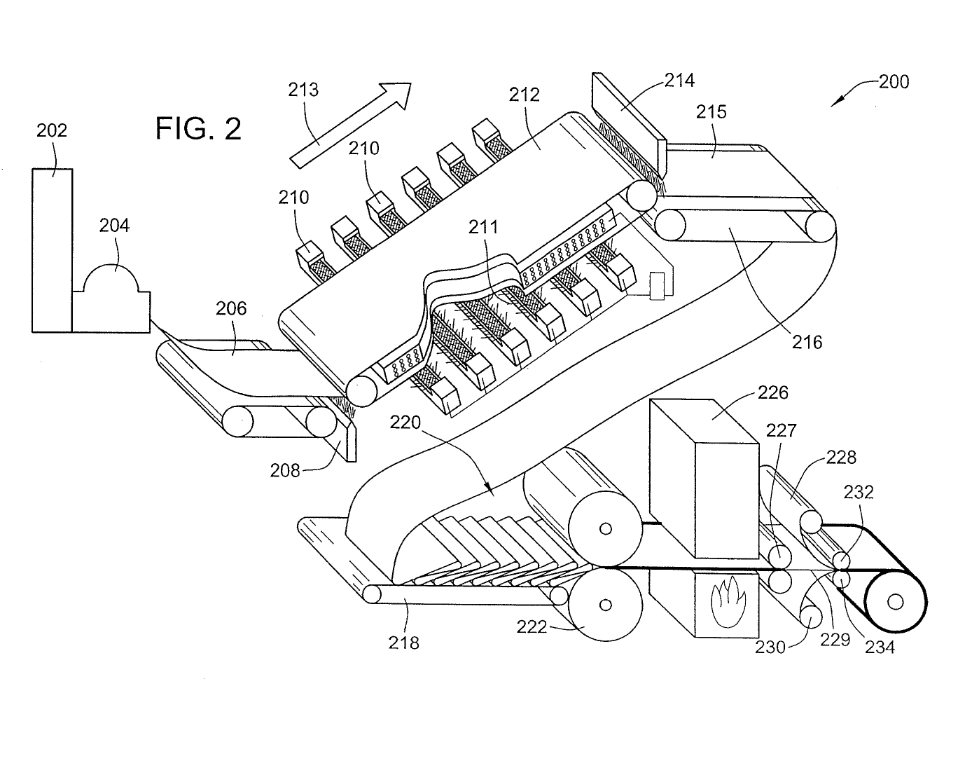

To accomplish the same, and as shown in FIG. 2, electrospun fine fibers can be deposited prior to finishing a filter media substrate structure and layer. For example, and depending upon the type and nature of the coarser fibers, the fine fibers can be entangled with the coarse fibers prior to calendering (or other forms of compression), prior to heat treatment for binding the coarser fibers, prior to further mixing or entanglement, prior to curing or solidification of the coarser fibers, and/or prior to, chemical or adhesive bonding of the coarse fibers to form a finished fiber composite filter media structure.

Referring to the embodiment of filter media according to the present invention in FIG. 1, the fine fibers 104 of the filter media 100 are shown to be substantially integrated in the coarse fibers 102 throughout the thickness of the coarse fibers. The coarse fibers 102 and the fine fibers 104 are effectively a single integrated filter media composite layer 106 comprised of both fine fibers and coarse fibers. Typically the fine fibers will be integrated throughout substantially the entire thickness and depth of the coarser fibers. Usually, fine fibers should be found over at least 15% and more typically at least 50% of the thickness and depth of the coarser fibers. In such embodiment, the coarse fibers can provide a structural support for filter media, while the fine fibers can divide pores between coarser fibers without occupying as much space thereby maintaining a relatively open media that is highly permeable but at the same time more efficient for removing and filtering smaller particle sizes. Further, the coarser fibers add more direct support to the fine fibers by being more closely integrated as opposed to a discrete subsequently added layer.

The composite layer 106 may be utilized by itself and can be pleated, fluted or otherwise arranged in a known filter element structure. Additionally, the embodiment in FIG. 1 is shown with optional layers 112, 114 arranged adjacent, and preferably, laminated on one or both surfaces 108, 110 of the fiber composite filter media 106. Layers 112, 114 may comprise multiple layers or a single layer and can be a protective layer (e.g. a scrim) and/or can be an additional filtration media layer, which may be electrospun fine fibers or other discrete layer of more conventional filter media.

The fine fibers 104 can be formed by electrospinning or other suitable process and as such have a very fine fiber diameter. For example, electrospun fine fibers typically have an average fiber diameter less than about 0.8 micron, and more typically less than 0.5 micron, and more preferably between 0.01 and 0.3 micron. The coarse fibers 102 typically have an average fiber diameter greater than about 1 micron. More typically, embodiments of the present invention will employ an average coarse fiber diameter of greater than 3 micron and even more typically between about 5 micron and about 30 micron. Such construction of the filter media 100 can improve filtration efficiency as the fine fibers 104 increase the ability to trap smaller particles. Smaller the diameter of the fine fibers, more fibers can be packed together without increasing overall solidity, thus increased filter efficiency.

The fine fibers 104 may be formed from different polymeric materials and solvents via an electrostatic spinning process. Examples of polymeric materials include polyvinyl chloride (PVC), polyolefin, polyacetal, polyester, cellulous ether, polyalkylene sulfide, polyarylene oxide, polysulfone, modified polysulfone polymers and polyvinyl alcohol, polyamide, polystyrene, polyacrylonitrile, polyvinylidene chloride, polymethyl methacrylate, polyvinylidene fluoride. Solvents for making polymeric solution for electrostatic spinning may include acetic acid, formic acid, m-cresol, tri-fluoro ethanol, hexafluoro isopropanol chlorinated solvents, alcohols, water, ethanol, isopropanol, acetone, and N-methyl pyrrolidone, and methanol. The solvent and the polymer can be matched for appropriated use based on sufficient solubility of the polymer in a given solvent. For example, formic acid may be chosen for polyamide, which is also commonly known as nylon. Reference can be had to the aforementioned patents for further details on electrospinning of fine fibers.

While the fine fibers 104 can improve filtration efficiency while maintaining a relatively open media, the fine fibers 102 may not provide a structural support necessary for the filter media 100 or for filter media handling and processing. For example, it would be difficult to pleat or otherwise arrange in a filter a fine fiber layer alone. Thus, in the preferred embodiment of FIG. 1, the fine fibers 104 are integrated with the coarse fibers 102 which can provide the necessary structural support for the filter media 100. The coarse fibers 102 may be formed from either or both natural cellulous fibers and/or synthetic fibers that may be made of different polymeric materials. The coarse fibers may be produced using any conventional fiber production processes to include but not limited to melt blowing, spun bonding, air laying, wet laying or dry laying.

FIG. 2 schematically illustrates a representative process of making the composite layer 106 using staple fibers. System 200 includes a chute feed 202, a carding device 204, electrospinning cells 210, and vacuum collector conveyor 212. The system 200 also includes calendering rollers 227, an oven 226, and laminating rollers 228, 230.

In the system 200, the web of coarse fibers 206 is formed from staple fibers using a dry laying or air laying process. The staple fibers used in this process are relatively short and discontinuous but long enough to be handled by conventional equipment. Bales of staple fibers can be utilized and separated and handled by the equipment. The staple fibers are fed to the system 200 through the chute feed 202. In the carding device 204, the staple fibers are separated into individual fibers and air laid to form the web of coarse fibers 206. At this point, the web of coarse fibers 206 can be loosely tangled together in a highly fluffed thick state and may not be bonded together. The web of coarse fibers can easily be pulled apart with very little manual effort and has little structural integrity at this point such that it is not considered a filter media substrate in the conventional sense.

The web of coarse fibers 206 is transferred to the vacuum collector conveyor 212 directed by an air knife 208, wherein the fine fibers 211 are electrospun from the electrospinning cells 210 and deposited on the web of coarse fibers 206. The electrospinning process in the system 200 can be substantially the same as the electro spinning process disclosed in Fine Fibers Under 100 Nanometers, And Methods, U.S. Provisional Patent Application No. 60/989,218, assigned to the assignee of the present application, the entire disclosure of which has been incorporated herein by reference thereto. Alternatively, nozzle banks or other electrospinning equipment can be utilized to form the fine fibers. Such alternative electrospinning devices or rerouting of the chain electrodes 209 of the cells 210 can permit the fibers to be deposited in any orientation desired (e.g. upwardly is shown although fibers can also be spun downwardly, horizontally or diagonally onto a conveyor carrying coarser fibers).

The electrospinning process produces synthetic fibers of small diameter, which are also known as nanofibers. The basic process of electrostatic spinning involves the introduction of electrostatic charge to a stream of polymer melt or solution in the presence of a strong electric field, such as a high voltage gradient. Introduction of electrostatic charges to polymeric fluid in the electrospinning cells 210 results in formation of a jet of charged fluid. The charged jet accelerates and thins in the electrostatic field, attracted toward a grounded collector. In such process, viscoelastic forces of polymeric fluids stabilize the jet, forming a small diameter filaments. An average diameter of fibers may be controlled by design of electrospinning cells 210 and formulation of polymeric solutions.

In the system 200, an electrostatic field is generated between electrodes 209 in the electrospinning cells 210 and the vacuum collector conveyor 212, provided by a high voltage supply 213 generating a high voltage differential. As shown in FIG. 2, there may be multiple electrospinning cells 210 whereat fine fibers 211 are generated. The fine fibers 211 formed at the electrodes 209 are drawn toward the vacuum collector conveyor 212 by the force provided by the electrostatic field. The vacuum collector conveyor 212 also holds and transfers the web of coarse fibers 206 in a machine direction 213. As configured, the web of coarse fibers 206 is positioned between the electrospinning cells 210 and the vacuum collector conveyor 212, such that the fine fibers 210 are deposited on the web of coarse fibers 206.

The web of coarse fibers 206 is typically fluffy and low in solid with large interfiber spaces. Thus, the fine fibers 210 formed by an electrospinning process which has smaller fiber diameters than the coarse fibers are dispersed in the interfiber spaces of the coarse fibers and on the surface of the web of coarse fibers 206, wherein the fine fibers are entangled with the coarse fibers.

An entanglement of the coarse fibers and fine fibers 215 are directed by an air knife 214 onto a conveyor 216, wherein the entanglement 215 can be mixed and thereby entangled further, if desired, such as by being folded into multiple folds. The entanglement 215 may be folded to 2 to 8 folds thick depending on a desired thickness and/or characteristics of the filter media 100. The folded entanglement 220 is transferred by a conveyor 218 to a set of rollers 222, wherein the folded entanglement 220 is compressed to a thickness appropriate to pass through an oven 226. As the folded entanglement 220 is heated in the oven 226, thermal bonding between the fine fibers and coarse fibers is effectuated for further integration. After exiting the oven 226, the folded entanglement 220 passes through a set of calendering rollers 227. The calendering rollers 227 are spaced from each other according to a desired thickness of a filter media. As the folded entanglement 220 passes through the set of calendering rollers 227, the folded entanglement 220 is pressed down into a single integrated filter media composite layer 229.

The folded entanglement 220 prior to being calendered can measure more than 2 inches in its thickness, wherein the fine fibers are entangled with the coarse fibers which are low in solidity with high volume of voids or interfiber spaces. When such entanglement 220 passes through the set of calendering rollers 227, the folded entanglement 220 is compressed such that the interfiber spaces in the coarse fibers are reduced, thereby further integrating the fine fibers and the coarse fibers. In one preferred implementation of the system 200, the folded entanglement 220 may be 2.5 inches in thickness which is compressed to form an integrated filter media in 1/16 inch thickness.

The integration between the fine fibers and the coarse fibers may involve solvent bonding, thermal bonding, pressure bonding and/or adhesive bonding. For example, when fine fibers are entangled with coarse fibers, some solvent remaining in the fine fibers from the electrospinning process can come in contact with the adjacent coarse fibers to effectuate a solvent type bonding between the fine fibers and the coarse fibers. To effectuate a sufficient solvent bonding between the fibers, the coarse fibers need to be soluble or at least react with the solvent in the fine fibers.

The integration between coarse fibers and fine fibers may be enhanced by pressure and heat. Thermal bonding is a process of using heat to bond or stabilize a web structure that consists of thermoplastic fibers. In thermal bonding of thermoplastics, parts of the fibers may act as thermal binders. In pressure bonding, an entanglement of fine fibers and coarse fibers is compressed such that interfiber spaces in the entanglement are reduced and fibers are pressed together and integrated.

In one embodiment, the coarse fibers are formed from a thermoplastic having a lower melting temperature than that of a thermoplastic of the fine fibers, such that the coarse fibers would soften first and fuse with the adjacent fine fibers to form an integrated fiber composite filter media. For example, the coarse fibers may be formed from polyvinyl alcohol (PVA) while the fine fibers may be formed from nylon which has a higher melting temperature than PVA. Such combination may be advantageous, since the fine fibers having a higher melting temperature can maintain their fine fiber size and shape during a thermal bonding process which can be advantageous to filtration capabilities as discussed previously. In other embodiments, the coarse fibers may be formed from a higher melting temperature thermoplastic than the fine fibers.

In the system 200, the fine fibers are laid upon the coarse fibers and attached therewith by solvent type bonding when the fine fibers with some solvent remaining come in contact with the coarse fibers. The entangled and solvent bonded fine fibers and coarse fibers are integrated by pressure applied by the set of calendering rollers 220. The calendering rollers 220 can also be heated to effectuate additional integration of fibers by a thermal bonding. The system 200 also includes the oven 226 for additional thermal bonding integration of fibers. The oven 226 may be located either before or after the calendering rollers 227 to heat fibers such that the fibers having lower melting temperature soften and act as thermal binders to bond with adjacent fibers.

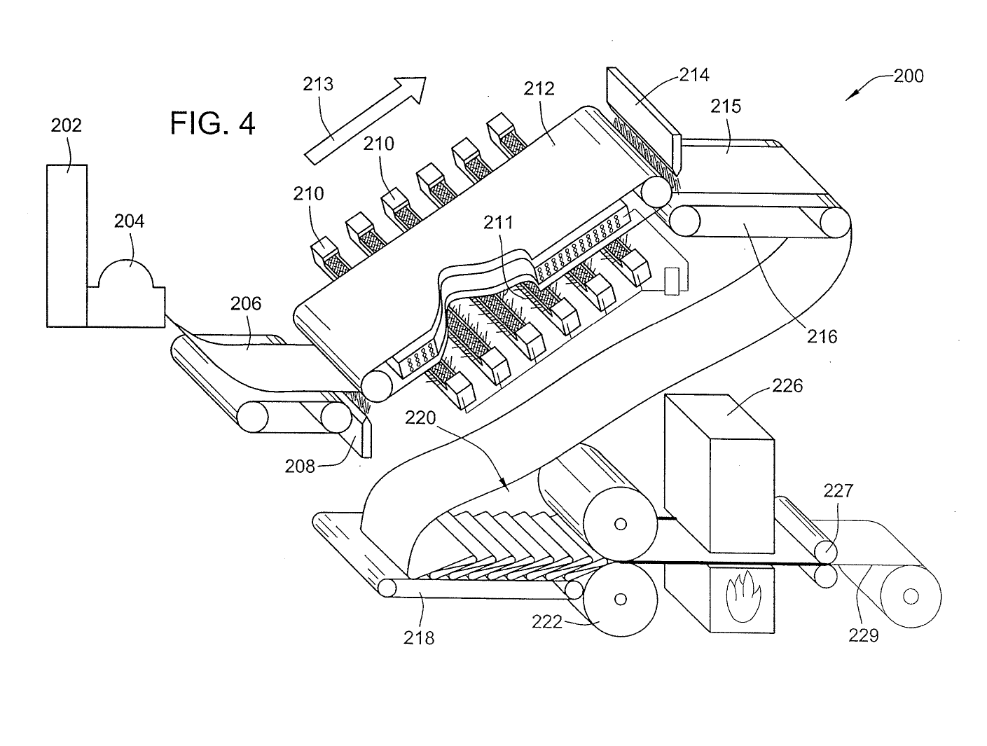

As shown in FIG. 2, the system 200 may further include laminating rollers 232, 234 wherein a discrete layer of porous material and/or filter media 228, 230 may be laminated on one or both sides of the web of integrated fiber composite filter media 229. Alternatively, the integrated fiber composite filter media 229 may be wound into a roll without any extra layers as shown in FIG. 4. In such an embodiment, the calendering rollers 227 may be cold rollers to compress and cool down the heated entanglement to set it into an integrated fiber composite filter media 229.

In certain embodiments, the system 200 can produce an integrated fiber composite filter media 229 having a fiber density gradient by varying the amount of fine fibers throughout the thickness media. For example, the electrospinning cells 210 may be programmed such that the amount of fine fibers gradually increases from one surface of the fiber composite filter media 229 to the other. Specifically, individual electrodes can be modulated (turned off and on) in sequence with the folding of the media to generate more or fewer fibers on different folds and thereby generate more fibers nearer the upstream or downstream face of the media. When the electrode is turned off (e.g. disconnected from a voltage source or made to be the same voltage as the collector electrode), fine fiber generation stops as there is no electrical force to generate fibers. Fiber generation restarts upon returning to the on state when the voltage differential is provided. The gradient density provides for different options. For example, for better depth loading, fewer fine fibers may be generated proximate the upstream face and a larger gradient density proximate the downstream face. In fact, a region of the media may be fine fiber free proximate one of the faces. Hence, the fine fibers may not be dispersed throughout the common layer depth. This may provide for a gradient efficiency trapping larger particles nearer the upstream face and smaller particles proximate the downstream face. As such, contaminant loading may be controlled. Alternatively, more fine fibers may be generated proximate the upstream face thereby providing for better surface loading. FIG. 3 schematically illustrates such integrated fiber composite filter media 300 with a fiber density gradient wherein the density of fine fibers 304 entangled with coarse fibers 302 increases from an upstream surface 308 to a downstream surface 310.

The integrated fiber composite filter media 100, 229 may be used either as a surface loading filter media or a depth filter media in various filter applications. The fine fibers in the integrated fiber composite filter media 100, 229 can make an effective depth filter by enhancing filtration capability to trap smaller particles. Further, the integrated fiber filter media having a fiber density gradient 300 can make a good depth filter by enabling loading of particles throughout its thickness.

There are potentially other ways to integrate fine fibers during the production of filter media layers or prior to finishing the filter media layer. For example, coarse fibers can be formed by a melt blowing process wherein a molten polymer is extruded and drawn with heated, high velocity air to form the coarse fibers. The coarse fibers can be collected as a web of the coarse fibers on a moving screen which is then integrated with the electrospun fine fibers as described above. Thus, other types of fibers other than staple fibers may be used. Other arrangements are also possible. Coarse fiber formation and the fine fiber formation may be closely arranged. For example, melt blowing extruder orifices and electrospinning cells are aligned adjacent and may be in alternating fashion. For example, the fiber production may start with a melt blowing orifice forming coarse fibers onto a moving screen, which is aligned with a subsequent electrospinning cell that forms and entangles fine fibers with the coarse fibers, which is aligned with a subsequent melt blowing orifice forming and entangling the coarse fibers with the entanglement of fine fibers and coarse fibers, and so on.

Coarse fibers may also be spun-bonded. In a typical spun-bonding process, a molten polymeric material passes through a plurality of extrusion orifices to form a multifilamentary spinline. The multifilamentary spinline is drawn in order to increase its tenacity and passed through a quench zone wherein solidification occurs which is collected on a support such as a moving screen. The spun-bonding process is similar to the melt blowing process, but melt blown fibers are usually finer than spun-bonded fibers. The spun-bonded coarse fibers may be first formed as a web which is integrated with electrospun fine fibers downstream, or the spun-bonded coarse fibers and the electrospun fine fibers may be alternatingly formed in a combined fiber production station as described in the melt blown process.

In another embodiment, the coarse fibers may be wet-laid. In a wet laying process, the coarse fibers are dispersed on a conveyor belt, and the fibers are spread in a uniform web while still wet. Wet-laid operations typically use ¼″ to ¾″ long fibers, but sometimes longer if the fiber is stiff or thick. Polyester, polypropylene, fiberglass and other synthetic fiber blends are well suited for wet laying process. Electrospun fine fibers may be deposited prior to curing or drying. Additional mixing or agitation may increase entanglement.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method of making a filter media, comprising:
forming a web of coarse fibers having an average fiber diameter of greater than about 1 micron;
electrospinning fine fibers and depositing the fine fibers onto the web of the coarse fibers, the fine fibers having an average fiber diameter of less than about 0.8 micron; and
integrating the coarse fibers and the fine fibers setting the web and the fine fibers into a single integrated filter media composite layer, said integrating occurring after said depositing of the fine fibers and involving at least one of the application of heat, pressure and mixing.

2. The method of making a filter media of claim 1, wherein said forming comprises air laying the coarse fibers into a state wherein the coarse fibers are not bonded together but only mechanically entangled, the fine fibers deposited onto the web is this state.

3. The method of making a filter media of claim 1 further comprising solvent bonding the coarse fibers and the fine fibers, wherein the solvent bonding is effectuated when a residual solvent in the fine fibers from the electrospinning comes in contact with the adjacent coarse fibers.

4. The method of making filter media of claim 1, wherein said integrating comprises pressure bonding after the fine fibers are deposited onto the web of coarse fibers, wherein the entanglement of the coarse fibers and the fine fibers are compressed and integrated to a desired thickness.

5. The method of making filter media of claim 4, wherein said integrating further comprises thermal bonding by applying heat after the fine fibers are deposited onto the the web of coarse fibers, wherein the pressure bonding and the thermal bonding of the entanglement of the coarse fibers and the fine fibers are performed by a heated set of calendering rollers.

6. The method of making filter media of claim 1, wherein said integrating comprises thermal bonding, by applying heat after the fine fibers are deposited onto the web of coarse fibers.

7. The method of making filter media of claim 2, wherein said integrating comprises further mixing of the fine fibers with the coarse fibers, wherein the entanglement of the coarse fibers and the fine fibers are folded into multiple folds and heat set and pressure bonded into a desired thickness.

8. A method of forming a filter media comprising:
forming a web of coarse fibers prior to completing a filter media substrate, the coarse fibers having an average fiber diameter of greater than about 1 micron; and
electrospinning fine fibers and depositing the fine fibers on the web, the fine fibers having an average fiber diameter of less than about 0.8 micron.

9. The method of forming a filter media of claim 8 further comprising solvent bonding the coarse fibers and the fine fibers, wherein the solvent bonding is effectuated when the fine fibers having a residual solvent from the electrospinning come in contact with the coarse fibers.

10. The method of forming filter media of claim 8 further comprising integrating the coarse fibers and the fine fibers into a single integrated filter media composite layer after the fine fibers are deposited on the web.

11. The method of forming filter media of claim 10, wherein said integrating comprises thermal bonding, wherein the coarse fibers having a lower melting temperature soften and fuse together and also bond with the fine fibers.

12. The method of forming the filter media of claim 10, wherein said integrating comprises pressure bonding wherein the coarse fibers and fine fibers are compressed together through a set of calendering rollers.

13. The method of forming the filter media of claim 10, wherein said integrating comprises mixing of the fine fibers with the coarse fibers, wherein the web of coarse fibers with the fine fibers are folded into multiple folds and pressure bonded into a desired thickness.

14. The method of forming the filter media of claim 8, wherein said forming comprises dry laying staple fibers.

15. The method of forming the filter media of claim 8, wherein said forming a web of coarse fibers comprises melt blowing coarse fibers.

16. The method of forming the filter media of claim 15, wherein said forming and said electrospinning are performed in an alternating fashion, wherein the coarse fibers and fine fibers are formed alternatingly and entangled.

17. A method of forming a filter media, comprising:
forming a web of coarse fibers having an average fiber diameter of greater than about 1 micron;
electrospinning fine fibers and depositing the fine fibers onto the web of the coarse fibers, the fine fibers having an average fiber diameter of less than about 0.8 micron; and thereafter,
heating the web with the fine fibers deposited thereon, the heating occurring at a temperature that is at or above the melting temperature of the coarse fibers and below the melting temperature of the fine fibers.

18. The method of claim 18, further comprising compressing the web with the fine fibers deposited thereon along with said heating to reduce the thickness of the filter media and to set the web at a desired thickness, the coarse fibers being thermally bonded and the fine fibers having a melting point higher than the coarse fibers.

19. The method of claim 17, further wherein said forming comprises laying the coarse fibers into a state wherein the coarse fibers are not bonded together but only mechanically entangled, the fine fibers deposited onto the web is this state, said heating setting the web.

20. The method of claim 19, further comprising mixing the coarse fibers and the fine fibers prior to the heating.
